(19) United States
(12) Patent Application Publication
(10) Pub. No.: US 2009/0235091 A1
(43) Pub. Date: Sep. 17, 2009

(54) Computer system for indexing and storing sensitive, secured, information on a non-trusted computer storage array

(75) Inventors: David Michael Kurn, San Francisco, CA (US); Michael David Dahmer, Jerome, ID (US)

Correspondence Address: Michael D. Dahmer, P.E., P.O. Box F, Jerome, ID, 83338, US

(73) Assignee: Systems Associates, Inc., Jerome, ID (US)

(21) Appl. No.: 12/322,935

(22) Filed: Feb. 9, 2009

Related U.S. Application Data
(60) Provisional application No. 61/028,526, filed on Feb. 14, 2008.

(51) Int. Cl. H04L 9/00; G06F 12/14

(52) U.S. Cl. 713/193; 380/277

(57) ABSTRACT

Preservation of sensitive electronic data records in the face of either natural or man-made catastrophes has become important. In some fields, such as the medical and legal fields, current law requires that such data survive these events, and be available to authorized users in a timely fashion. This invention presents a method to protect sensitive data such that the systems used for preservation need be neither private nor secure. Data sets are replicated at multiple servers that can be geographically distant increasing the survivability of these records. Both the name and the contents of these files are private to the client, and are not available even to the operators of the disaster recovery system. By allowing the preserved data to be accessible on the public Internet, yet be undecipherable, the confidentiality and survival of such data is significantly improved. This preservation methodology minimizes the data to be sent by sending only new and changed files, and multiple geographic sites are supported.

### REFERENCES CITED

U.S. Patent Documents

| | | |
|---|---|---|
| 3,657,476 | April 1972 | Aiken |
| 4,405,829 | September 1983 | Rivest et al. |
| 4,641,274 | February 1987 | RE34954 May 1995 Haber et al. |
| 4,922,417 | May 1990 | Churm et al. |
| 5,202,982 | April 1993 | Gramlich et al. |
| 5,532,920 | July 1996 | Hartrick et al. |
| 5,579,501 | November 1996 | Lipton et al. |
| 5,765,152 | June 1998 | Erickson |
| 5,778,395 | July 1998 | Whiting et al. |
| 5,852,666 | December 1998 | Miller et al. |
| 5,914,938 | June 1999 | Brady et al. |
| 5,914,938 | June 1999 | Brady et al. |
| 5,915,025 | June 1999 | Taguchi et al. |
| 5,931,947 | August 1999 | Burns et al. |
| 5,940,507 | August 1999 | Cane et al. |
| 5,978,791 | November 1999 | Farber et al. |
| 5,990,810 | November 1999 | Williams |
| 6,041,411 | March 2000 | Wyatt |
| 6,052,688 | April 2000 | Thorsen |
| 6,067,623 | May 23, 2000 | Blakley, III et al. |
| 6,122,631 | September 2000 | Berbec et al. |
| 6,205,533 | March 2001 | Margolus |
| 6,272,492 | August 2001 | Kay |
| 6,374,266 | April 2002 | Shnelyar |
| 20020071560 | June 2002 | Kurn et. al. |
| 20020071561 | June 2002 | Kurn et. al. |
| 2002/0071563 | June 2002 | Kurn et. al. |
| 2002/0071564 | June 2002 | Kurn et. al. |
| 2002/0071565 | June 2002 | Kurn et. al. |
| 2002/0071566 | June 2002 | Kurn et. al. |
| 2002/0071567 | June 2002 | Kurn et. al. |
| 2002/0073309 | June 2002 | Kurn et. al. |
| 6,415,280 | July 2002 | Farber et al. |
| 6,430,618 | August 2002 | Karger et. al. |
| 2002/0141593 | October 2002 | Kurn et. al. |
| 2002/0157880 | October 2002 | Kurn et. al. |
| 6,557,102 | April 2003 | Wong et al |
| 6,584,466 | June 2003 | Serbinis et al. |
| 6,601,172 | July 2003 | Epstein |
| 2003/0028761 | February 2003 | Platt |
| 2003/0140051 | July 2003 | Fujiwara, et al. |
| 6,901,512 | May 31, 2005 | Kurn et al. |
| 2005/0157880 | July 2005 | Kurn et. al. |
| 6,940,980 | September 2005 | Sandhu et al. |
| 7,039,946 | May 2006 | Binding et al. |
| 7,100,049 | August 2006 | Gasparini et al. |
| 7,181,016 | February 2007 | Cross et al |
| 7,197,765 | Mar. 27, 2007 | Chan et al. |
| 7,254,838 | August 2007 | Kim et al. |
| 7,272,231 | September 2007 | Jonas et al. |
| 7,418,727 | August 2008 | Lin et al. |
| 7,412,462 | August 2008 | Margolus, et al. |
| 7,426,577 | September 2008 | Bardzil et al |
| 7,437,551 | October 2008 | Chan, et al. |
| 7,457,959 | November 2008 | Margolus, et al |
| 7,470,606 | December 2008 | Yin, et al. |

### OTHER REFERENCES

Rabin, “Fingerprinting by Random Polynomials,” Center for Research in Computing Technology, Harvard University, Technical Report TR-15-81 (1981). cited by other

Devine, Robert. “Design and Implementation of DDH: A Distributed Dynamic Hashing Algorithm.” In Proceedings of 4th International Conference on Foundations of Data Organizations and Algorithms, 1993, pp. 101-114. cited by other

Miller et al, “Strong Security for Distributed File Systems”, 2001 IEEE, pp. 34-40. cited by other.

Rivest, “The MD5 Message-Digest Algorithm,” Network Working Group, Request for Comments: 1321, MIT Lab for Comp. Science and RSA Data Security, Inc. (April 1992). cited by other.

Schneier, Bruce. Applied Cryptography: Protocols, Algorithms, and Source Code in C. Chapter 10 p. 226, 1996*.

### RELATED APPLICATIONS

None

### BACKGROUND OF INVENTION

1. Field of the Invention

The field of the invention is related to file protection and security in a non-trusted computer/storage array environment. More specifically, the present invention is related to storing information, data, and or file structures from a secure environment on storage arrays that are in the public internet environment, thus these storage arrays are non-trusted.

2. Description of the Related Art

Disaster Recovery

Modern data processing techniques require that data be maintained on storage devices. When this data is volatile, and where the data cannot easily be recreated, techniques have evolved to allow for the restoration of such data in the event of some sort of catastrophic failure, man-made, intentional or un-intentional, or natural event. In the current form, this type of recovery requires that both the originating site(s) and the storage site be trusted so as not to compromise the information. A significant example is government transmission of classified material from one SCIF (Secure Compartmentalized Information Facility) site to a second SCIF location.

The security of both the originating and storage sites require some form of encryption in which the authenticity and necessary security aspects are shared at some level of a trust relationship. Often these trust relationships are implemented through third parties and are erected as part of the online transactional infrastructure.

The level of this trust relationship may vary with respect to legal issues, and with respect to incursion of liability risk by the trusted storage site. This requirement of assumption of liability risk may require trusted storage sites to demand that the originating site divulge certain confidential information. The most common type of this confidential information is the data given as part of the lost password scenario. The trusted storage site prior to this invention must have confidential information in order to recover from originating site's operational mistakes or failures.

Paradigm

There are several types and kinds of concepts and algorithms currently in use in cryptographic systems for disaster recovery, but a more streamlined concept employs only hash (also known as digest or checksum) algorithms, and symmetric encryption algorithms. Computationally expensive public key, or key-negotiation processes are not involved since sensitive data such as private keys never leave the trusted environment.

Hash Algorithms

A hash algorithm is a mathematical function H(x)→y defined on bit-string of arbitrary length (x) (any data value can be thought of as a string of bits), which produces a bit-string of fixed length (y), with the following desired properties:
The function is easy to compute, that is, it is relatively easy to compute y given x;
It is infeasible (or very difficult) to create an x that produces a known y.

The chance of collision is small, that is, it is extremely unlikely that two different values of x will produce the same y. Ideally, this probability should be close to 2^{-w(y)}, where w(y) is the number of bits produced by algorithm H.

There are several algorithms accepted today as being good approximations to the ideal, and they include:

| | Width | |
|---|---|---|
| Name | (in bits) | Comments |
| MD5¹ | 128 | Currently deprecated because of suspected |
| | | algorithmic flaws |
| SHA-1² | 160 | |
| SHA-256 | 256 | A family of very similar algorithms, producing |
| SHA-384 | 384 | results of different widths |
| SHA-512 | 512 | |

¹R. L. Rivest, “The MD5 Message Digest Algorith”, RFC 1321, April 1992
²D Eastlake 3^{rd}, et al., “US Secure Hash Algorithm 1 (SHA1)”, September 2001

### Symmetric Encryption Algorithms

A symmetric encryption algorithm is one that transforms a bit-string into another bit-string with the following properties:
The algorithm operates on a word at a time, where the word-size varies with the algorithm (typically 64 or 128 bits), taking a word of plain-text and producing a word of cipher-text;
A key (typically the same size as the word size) is used to control the process;
It is computationally infeasible to reconstruct the plain text from the cipher text without knowledge of the key.

Several methods are used to mitigate certain weaknesses in the encryption process. Since sequences of characters can recur, a block-by-block encryption process would create identical cipher-text words from identical plain-text words. Thus a ¹ R. L. Rivest, “The MD5 Message Digest Algorith”, RFC 1321, April 1992 ² D Eastlake 3^{rd}, et al., “US Secure Hash Algorithm 1 (SHA1)”, September 2001 technique known as Cipher-Block-Chaining is used, in which each successive plain-text word; is exclusive-or'ed with the previous cipher-text word before encrypting. In the case of the first word (or first 8 to 16 bytes of the data), where there is no previous cipher word, two methods are commonly used:
Preceding the plain-text with a word containing random values, which will be discarded upon decryption;
Inventing a random value and perform an Exclusive-Or with the first word of plain text before encrypting. This value is known as an initialization-vector, and must be saved in the clear to allow for decrypting.
A padding method is used to increase the length of the plain text to make it a whole number of words; this is removed when the data is decrypted.

Disaster Recovery Processes

Many data processing systems have had the need for preserving critical data against hardware, software, and human errors. Several techniques were used, including mirroring and off-line storage. For example, mirroring, also known as RAID-1, is a technique wherein data written to disc is actually written to two discs at the same time. Under normal conditions, this allows the retrieval of data to occur from either disc, but should one of the discs fail, the other of the pair is used until the failed device is corrected and resynchronized.

The use of off line storage, prior to the widespread use of the Internet, involved copying important data to an external storage device, such as magnetic tape or other removable storage devices. These storage devices were then often moved to a physical storage area, sometimes geographically removed. Under these conditions, the recovery of the data, even though it might take hours or days, was an acceptable alternate to total data loss, or regeneration of the data from often-unavailable records.

Sensitive data, where it would be unacceptable if the information became known to unauthorized people, presents a particular problem, both in transportation and storage. Transporting data to a room down the hall might represent acceptable risk, but when outside shippers or the Internet gets involved, the protection of the data becomes an issue. Many real events have emphasized the need to protect the data in transit. As a result, responsible disaster recovery and/or archiving procedures now use encryption for such data in transit over the internet, and should encrypt the data stored on physical media being transported.

Several systems exist which provide on-line archiving using the Internet to transport the data. Some provide no security, and are not relevant to this discussion. There are also products that encrypt the data in transit only. This can be an acceptable tradeoff when the storage facility is trusted.

There are products that not only encrypt the data in transit, but also store the data on the archival media in encrypted form. The data being archived is thus encrypted for transit, decrypted at the archive site, and then re-encrypted for storage. The weak point with these products is that the keys for decrypting the archived data must reside at the archive site, thus increasing the number of people that need to be trusted.

There are also products that encrypt the files at the point of origin, and then transport them to the disaster recovery site for storage, with no further encryption processing needed. These methods benefit from the cost savings of avoiding extra cryptographic cycles. If, however, the provider of the disaster recovery facility states that they can help you recover lost keys if you properly authenticate yourself to their support staff, it means that the support staff has access to sensitive information, and increases the set of individuals that must know sensitive data.

A better level of security is achieved if the encryption keys and other potentially sensitive information never leave the system on which the original data resides and encryption processing occurs. This implies that the owners of the archival storage facility need be trusted only to keep the data, and provide access to it when requested. These remote personnel have no access to the contents of the data, and thus cannot divulge sensitive information (assuming that “good cryptographic practice” is used). Furthermore, the originators can detect the insertion of false data if suitable cryptographic safeguards are used.

However, these systems, to some degree, lack certain features that a more sophisticated, streamlined concept would address:
1. The names of the files that are archived may be visible at the target, unless the names are encrypted or otherwise hidden;
2. Even if the names are encrypted, some information can be gleaned from the length of a file name, and that could be undesirable;
3. If names are encrypted, it is difficult to do incremental archiving except based upon file modification times;
4. There is often no concept of a snapshot, that is, a collection of files all of which are connected and consistent;
5. Should the archival storage fail or be otherwise unavailable, no recovery is possible.

A more sophisticated concept would address these issues by identifying each file in an archive by an index. An index is a value used to identify the contents (not the name) of the unencrypted file, and is the hexadecimal representation of the hash (or digest) of the file's contents. The user selects a particular hash algorithm from a limited set, no two of which produce hash values of the same length. Assuming the non-collision assertions of the hash algorithms are met, it can be said two files have the same index if and only if they have the same contents.

Again assuming the non-reversibility of a hash, and the infeasibility of inventing a false file that produces a known hash, the client would be able to detect any altered files.

A more sophisticated concept would consider each separate archive operation to be a snapshot containing the then-current values of a collection of files. Independent of modification time stamps on files, or file names or copies, the index of a file with unchanged contents is unchanged. This allows an efficient test against the old files in archival storage and thus can avoid an unneeded encryption and transfer.

A more sophisticated concept would create an inventory of all the files that are part of the snapshot (whether uploaded this time or not), and saves that on the remote storage. This inventory contains for each inventoried file:
The encrypted value of the original file name (padded with trailing blanks to avoid revealing the approximate file-name size), and the file modification timestamp;
The index name as defined above.

Included in the inventory file is also a hash of the cryptographic variables used, namely of a line consisting of a blank separated list of:
Name of the hash algorithm;
Name of the encryption algorithm;
The key-phrase used to generate the encryption key.

And finally, a set of archival storage servers is designated to hold the necessary files, and if there are at least two servers designated, the survivability and accessibility of the data is significantly increased.

As a result, the streamlined and sophisticated concepts in our application for patentability permit those who require access to critical data in the face of natural, accidental or man-made failures, to use these procedures to transport their data over insecure network connections, and save their data on insecure public server systems. If the original data site, and the archival server systems are geographically remote, the risks induced by natural disasters are also mitigated.

### SUMMARY OF THE INVENTION

This invention consists of four functional areas:
The Client Function
The Service Function (invoked by the web server)
The Replication Function (invoked periodically)
The Administration function
   Source code for the first three functions is listed in Compact Disk 1 entitled “IdahoDataSafe™ Source Code. The administrative function is currently performed manually using common tools such as SFTP and SSH.

The Client Function is contained in an executable program that runs on the client system, the system that has the data in need of archiving. It manages the cryptographic functions, and uses HTTP protocol to communicate with the servers involved in the archiving function.

The Service Function is contained in a program that resides on each of the public IdahoDataSafe™ servers. Invoked by the web server (such as Apache), this function interprets the HTTP requests sent by the client and the replication functions, and provides answers. Except for the IdahoDataSafe™ user-id/password verification operation, no cryptographic functions are performed.

The Replication Function is contained in a program that resides on each of the public IdahoDataSafe™ servers. It is invoked periodically (by a service similar to cron on Unix systems) and supervises the movement of archival data between the servers to keep the data content consistent and up to date.

The Administration Function is responsible for maintaining the properties of each IdahoDataSafe user and replicating that information to all the servers. This involves properties including name, password, server assignments, and space quotas. The administration function also manages the overall IdahoDataSafe™ server properties, and distributes updated copies of the program material to the servers when needed.

### BRIEF DESCRIPTION OF THE DRAWINGS

None

### DETAILED DESCRIPTION OF THE INVENTION

Definitions: The software contained herein is listed in the CD-Rom named IdahoDataSafe Source Code is hereby included in this detailed description .

Crypto Suite

A crypto-suite is a four-tuple consisting of:
1. A name (or label) by which this suite is identified. This name must be unique among the crypto suites managed by the trusted user. In the IdahoDataSafe™ design implementation, this name is limited to the letters A-Z, the digits 0-9, and is case insensitive;
2. The name of a hashing or digesting algorithm. This name is selected from a list limited to the hashing algorithms supported by the cryptographic software available to the client program. In the IdahoDataSafe™ design implementation, the list consists of:
   a. MD5 (supported, but not recommended);
   b. SHA1;
   c. SHA-256;
   d. SHA-384;
   e. SHA-512/
3. The name of a symmetric encryption algorithm. This name is selected from a list limited to the encryption algorithms supported by the cryptographic software available to the client program. In the IdahoDataSafe™ design implementation, this list consists of:
   a. AES-128;
   b. AES-192;
   c. AES-256;
   d. BF (Blowfish);
   e. CAST5.
4. A pass-phrase used by the cryptographic software to generate a symmetric key. In the IdahoDataSafe™ design implementation, this pass-phrase consists of a string of printable characters, where leading and trailing blanks are ignored. The IdahoDataSafe™ software does not generate the key, but relies upon the underlying cryptographic software to do so.

It is important that the trusted client user keep this information private (it is not shared with the IdahoDataSafe's™ non-trusted administrator), choose algorithms and pass-phrases consistent with the security and privacy needs of the client, and protect those values against loss. If these values are lost, and assuming the cryptographic algorithms have not been invalidated by new discoveries, data from IdahoDataSafe™ cannot be recovered. The requirement that the trusted user keep the crypto-suite data significantly lessens the risk liability of IdahoDataSafe™. The privacy of the protected data structure on the IdahoDataSafe™ servers relies upon the computational infeasibility of attacking the encryption algorithms and the quality of the pass-phrase.

Mask of a File

The mask of a file encodes the name and time stamp the real file name and time stamp such that the original values are available only with the crypto-suite values. To avoid the cryptographic error of matching cipher texts given the same initial characters (which can occur frequently in lists of fully-qualified file names), an initialization vector or salt is used.
a. The time-stamp of the file is constructed by representing the time when the file was last modified as an integer number of seconds since some system-defined starting point. Note that we assume that recovery will occur on a system with a compatible system time;
b. A string is constructed by catenation of the following values;
   The integer representation of the file's modification time stamp;
   A separator (such as a single blank);
   The fully qualified name of the file (including the drive letter if relevant)
c. The above string is encrypted, using:
   The encryption algorithm specified in the crypto-suite, and using Cipher Block Chaining (CBC) encryption;
   If the salt method is used, the client program directs the cryptographic software to generate a random salt. This is the method used by the IdahoDataSafe design implementation. The cipher text will begin with the encrypted salt value, which is discarded during a decryption process;
   If the Initialization Vector method is used, a random 64-bit value is generated, and specified to the cryptographic software. This value must also be included in the clear in the resultant mask
   The encryption key derived by the cryptographic software from the pass-phrase in the crypto-suite;
d. Some cryptographic software packages mark results by beginning the salted encrypted string with a fixed set of characters, such as “SALTED_”. These bytes can be removed, since they can be restored when decrypting this string;
e. The result of the encryption, with the removal of the salt marker, is then converted to a printable result. The IdahoDataSafe™ design implementation uses a base-64 representation.

Index of a File

The index of a file is a name that identifies the contents of a file. There is no information concerning the name of the file, only the contents. It is constructed by taking the value of the hash (or digest) of the file, using the trusted, user selected hash-algorithm identified named crypto-suite.

Since the hash values are used in protocols that are limited to printable characters, the values are converted into a printable representation, such as hexadecimal or base-64. The current IdahoDataSafe™ design implementation uses a hexadecimal representation.

The Client Function

The client is the entity that has data to be archived. As part of the IdahoDataSafe™ registration process, the client and the IdahoDataSafe™ administrator have agreed upon an IdahoDataSafe™ user name and password, with which the client identifies itself to the IdahoDataSafe™ servers, and the client has obtained a copy of the client program.

The Client Function—User Controls

The user of the client program performs the following functions:
1. Identify the computer that will be performing the archiving function. This machine must have access to the data to be archived, and must have a network connection to the set of IdahoDataSafe™ servers. In the description below, this is called the client computer;
2. Install the IdahoDataSafe™ software on the client computer. This installation may include installing other public support software if needed.
3. Define one or more crypto-suites;
4. Specify what files and/or file sets are to be included in the periodic archive. Although the set of files may vary from one archive to the next, the IdahoDataSafe™ operation is optimized to an environment where between archival runs, the set of files remains mostly constant, and only a few files change;
5. Initiate an archival operation. The first archive run must upload all the files;
6. Schedule periodic archive runs, on some convenient interval such as once per day, or once per business day, which need not be attended.

Should a recovery of an archival run be needed, for example after the loss of data, the user again uses the client program to initiate a recovery operation, in which the user specifies:
1. The IdahoDataSafe™ user ID and password;
2. The date of the snapshot. The system will deliver the latest snapshot that is on or before the requested date;
3. Where the files are to be stored on the client computer (they are typically not returned to their original site);
4. If the primary IdahoDataSafe™ server is not available, the user may specify that the data be retrieved from the secondary server

The Client Function—Interacting with the Service Function

Once the requisite information for an archive run is present, the client program performs the following steps:
1. The set of files to be archived is derived from the specifications given by the user;
2. A work-list is computed. This work-list contains one record per file to be archived. If all the files in this operation use the same crypto suite, an initial record may be created in which the values of the crypto suite are recorded. This recording can be a hash (digest) of the crypto suite values, since its purpose is only to detect changes when the work list is used at a later time. Otherwise, this information is recorded with each subsequent file-record
3. For each file being archived, a record is created containing:
   1. The local fully-qualified name of the file to be archived, whence the program can examine and retrieve that file;
   2. The hash of the file's contents, using the hash-algorithm specified by the current crypto suite, converted into hexadecimal notation;
   3. The size (in bytes) of the original file;
   4. The last modification date of the original file;
   5. The mask of the file (which encodes the original name and time-stamp), in base-64 notation.
4. The work list is saved on the client machine, which allows the client software to save the re-computation of the digest and/or mask if the file in question has not changed size or modification date. The work list reuse process is an optimization, and does not affect the overall logical process.
5. The work-list is a full and complete listing of all the files that are to be included in the current archive. The list contains sensitive information, and does not leave the trusted client's computer.
6. The client program communicates with the IdahoDataSafe™ servers, using the client's IdahoDataSafe™ user-ID and password, and obtains the IdahoDataSafe account information. This includes:
   1. The identity of the primary IdahoDataSafe™ server assigned to this account;
   2. The identity of the secondary IdahoDataSafe™ server assigned to this account;
   3. Warning or error messages specified by the IdahoDataSafe™ administrator, which may preclude the completion of the backup operation;
   4. An indicator of whether the client should try to send data to the primary and secondary concurrently, or to the primary only relying upon the replication function to populate the secondary site. This option reflects the administrator's choice for network optimization.
7. The client program communicates with the user's primary IdahoDataSafe™ server, and obtains a complete listing of all files currently archived. This list is transmitted in the clear, because it contains a list of indexes and thus contains no sensitive information. Inventory file names are not sent.
8. An inventory is constructed from the work list. The first line in the inventory contains:

CRYPTO-SUITE-HASH hashvalue

where hashvalue is the MD5 hash of a string consisting of:
a. the chosen hash-algorithm name (lower-case);
b. a single blank character;
c. the chosen encryption algorithm name (lower-case without—cbc at the end);
d. a single blank character;
e. the encryption key phrase.

Subsequent lines identify each file that was included in the archive as listed in the work-list, and contains
a. The index of the file, which is also the name under which the file is stored on the server, as recorded in item (2) of the work-list, followed by the three letters “.dat”;
b. A single space;
c. The mask of the file, item (2) of the work-list, in base-64 notation.
9. The client program communicates again with the user's primary IdahoDataSafe™ server, and transmits a copy of the inventory, under a name that represents the current local civil time. In the IdahoDataSafe™ design implementation, this name is constructed in the form inv-yyyyMMddhhmmss.dat, where:
   1. yyyy represents the current year
   2. MM represents the current month (01 . . . 12)
   3. dd represents the current day of month (01 . . . 31)
   4. hh represents the current hour (00 . . . 23)
   5. mm represents the current minutes (00 . . . 59)
   6. ss represents the current seconds (00 . . . 59)
10. For each file in the work-list, the client program checks the file list obtained in step 6, and if the mask of the file mentioned in the work-list does not exist in the file list, it is encrypted and sent as follows:
   1. The source file is compressed to a temporary work file. Any compression algorithm can be used since the decompression will occur only on compatible systems;
   2. The compressed work file is encrypted using: the encryption algorithm specified in the work list; a pass-phrase constructed by catenation of the encryption phrase and the hash value; CBC encryption is used and a random salt is generated. This method of constructing the pass-phrase implies that a different encryption key is used for each file;
   3. The client communicates with the server and sends the result under the index name;
   4. If the options so specify, the result is also sent to the secondary IdahoDataSafe™ server;
   5. When all files have been transmitted, a request is sent to the IdahoDataSafe™ server asking for “finalization” operations (described below under Service Functions), and returns information back to the client for presentation to the user.
   6. Termination of file transmission and return of information to the user ends the archival process.

The Service Function

The service function executes on the server, and is an application invoked by the server computer's web server. It executes under user identity assigned to the IdahoDataSafe™ system on the server, and is unrelated to the user referred to at the client machine.

The service function can run on an insecure computer. It only needs to use a simple authentication protocol to verify that the client is indeed the correct client. If this authentication is false, files can be deleted or added, but neither the contents of those files nor their names can be revealed. The service function does not need supervisory privilege, but utilizes the time-driven functions (cron) typically available.

The service function interprets the following requests.

Get Account Data

The process returns the administrator-defined values to the client, including:
1. Identity of the primary server
2. Identity of the secondary server
3. Method of file recovery (primary only, or both in parallel)
4. Quota and space usage information
5. Messages from the administrator

List all Files

The process returns a list of all files currently on the server owned by this account. Note that this list is a list of file-masks.

Put a file

The process transmits an encrypted file for storage, and identifies the mask or inventory name under which it to be stored.

Get a file

The process requests the return of a saved file, identified the mask

Get an Inventory as of a given date

The process returns the contents of the most recent inventory on or before the date indicated in the request

Finalize

The process examines every file and every inventory and deletes files that are not mentioned in any inventory. It also allows for the enforcement of administrative policies, such as quota controls, and the deletion of old inventories when the number of them reaches a policy-defined limit or age, or the total amount of storage exceeds some policy-defined limit.

The Replication Function

The replication function operates periodically on the server, and is responsible for maintaining the multiple copies of the data in synchronization. For this function, a periodic scheduling function (such as cron) is used. The basic steps pretend to be a client with respect to the other sites, and send data as needed. To avoid unnecessary file transmissions, some heuristics are applied to decide when to transmit files.

The basic cycle consists of steps as follows:
1. Every hour or so (this time is not critical), the process awakes and scans through all IdahoDataSafe™ users known to the local system. This list is kept in a file that is identical on each site, and is maintained by the Administrative function.
2. For each IdahoDataSafe™ user (herein called an i-user), the program identifies the “other” server, and issues the Is verb, as outlined below in the discussion of protocols. This obtains a list of files on that server and includes inventory files.
3. The list of files is compared to the files that are present locally.
4. Any file present locally but absent remotely, is transmitted using the pf verb, as outlined in the protocol discussion below.
5. A finalize verb is sent to the remote.
6. To avoid hashing, the primary will transmit files to the secondary whenever it sees that it is missing, but the secondary will transmit to the primary only if the file is 24 hours old.

The Administrative Function

The administrative function exercises overall control over the IdahoDataSafe network.

The functions include:

Creating and deleting IdahoDataSafe users;

Assigning servers, which may be geographically dispersed, to IdahoDataSafe users;

Assigning quotas to each IdahoDataSafe user;

Controlling whether uploads will be serialized or in parallel. In the serialized mode, the client uploads to the primary server, and the server will transmit the data to the secondary site. In the parallel transmission mode, the client will send data to both primary and secondary server. The decision is typically based upon considerations of network speeds;

Specifying alert messages to be delivered to IdahoDataSafe users;

Controlling whether an IdahoDataSafe user is allowed or forbidden to perform an archive operation. This can be used to enforce non-payment of fees.

The method in which the administrator performs these functions is left to specific implementations, since the trusted administrator of the non-trusted server(s):

Has access to all servers in the IdahoDataSafe network;

Makes sure the information on each of the servers is consistent.

Client Server Protocol—Protocol on the Wire

The client and server(s) communicate using HTTP protocol defined by RFC 2116.

The Requests

All requests to the server have the following URL structure:

action/idahodatasafe/i-name/_isafe_?F=verb_id or;
action /idahodatasafe/i-name/_isafe_?F=verb_id_args.
where:

action is one of the http codes of GET or POST. Only the PF verb uses POST.

i-name is the IdahoDataSafe user name the client got at initial activation. Case insensitive.

verb is one of the requests listed below.

id is the cryptographic credentials that lets the server know that it's a legitimate client talking. The id value is computed:

Take the value of UTC seconds-since-1-1-1970 as most Unix systems provide, represented in decimal. Use OpenSSL (or substitute) to encrypt this value (aes-128, with salt, key based upon the user's IDS password), and get the result in Base64. OpenSSL precedes the result with the eight bytes containing ‘SALTED_’, so first 10 characters of base64 are removed (which encodes the first 60 bits of answer which are constant), and return the result.

The value will be tested in the server to make sure that the encrypted time value is within a reasonable time of the server time.

args occurs on some requests, and conveys additional information.

In all requests, the standard http response code of 400 is used to specify that the user is not known or that the password fails to meet the tests.

The client uses the verb-names in upper case, and the replication function uses verbs in lower case. This distinction is used only for statistics to report the number of files uploaded.

The QQ verb

The QQ verb is a query function, and asks the server for user information. The response comes back as a text/plain response. All responses of relevance are between a line containing,

—BEGIN—

and a line containing,

—END—

or end of response. The responses include lines with:

| | |
|---|---|
| -CHECK-- a b | Defines the version number for the client program. Only |
| | the first blank-separated value is relevant. |
| -PROPS-p v | Defines user property ‘p’ to be ‘v’ The user properties |
| | are listed below. |
| Other | Any other line should be quietly ignored anticipating |
| | future extensions. |

The properties maintained for each user are set by the administrator, but are available to all instances of the server. These properties include:

| Property | Use |
|---|---|
| IdahoDataSafe ™ | Identifies the user within the IdahoDataSafe ™ |
| user name | environment |
| Password | The password used for access |
| Serialize | A value specifying whether clients should send |
| | files in parallel to both primary and secondary |
| | servers, or serially first to the primary then to |
| | the secondary. The value of “yes” says serially, |
| | the value “no” says in parallel |
| Hosts | The names of the primary and secondary servers for |
| | this account. |
| Quota | Specifies the maximum amount of storage allocated to |
| | this user., as an integer, optionally suffixed by the |
| | g, m, or k, representing a multiplier of gigabyte, |
| | megabyte or kilobyte. |
| Note | If present, it contains a message to be conveyed to |
| | the client, intended to be used to send warnings. |

The LS verb

The LS verb asks for a listing of all data files of this user. The response comes back as text bracketed between the—BEGIN—and—END—lines (or end of response). Each line contains,

Index-name.dat (white-space) size . . . (line-feed)

for example:

fc60abcdef012345679809.dat 2549843

where

index-name is the hash of the contents of the original file, using the hash algorithm associated with the crypto suite. Note that the server does not directly know which hash algorithm was used, this is just the name of the file on the server's discs.

white-space represents one or more (space/tab) characters.

size is the size of the file on disc. This value is ignored by the client, but is used during the synchronization process.

. . . indicates that more information may be added in the future.

line-feed marks the end of the line.

The PF verb

The ‘pf’ verb transmits a file to the server. The arg field of the request conveys the mask of the file, i.e., the name under which the file is to be stored on the disk.

The server will, however, recognize two kinds of files, and reject all others:
1. Data files, which consist of at least 32 hexadecimal characters, and end with .dat, such as: abcdef0123456789.dat;
2. Inventory files, which begin with inv- , contain exactly 16 digits and end with .dat, such as: inv-20090202052733.dat.

The FI verb

The FI verb finalizes a backup function. In response, the server sends information bracketed in—BEGIN—and—END—, terminated by line-feed, the following text:

| --DATA-- a b | Conveys information back from the server, ‘a’ is the | |
|---|---|---|
| | name of the data, b is the contents. The ‘b’ field goes | |
| | until end of line. The data includes | |
| | total_size | Count of total number of bytes used |
| | Old_inventory | Date of oldest inventory file, in form |
| | | yyyymmddhhmmss |
| | Old_size | Amount of bytes releasable if oldest |
| | | inventory is deleted |
| | inventory_count | Count of inventories |

| | |
|---|---|
| Other | Any other line is meant to be displayed to the client from |
| | the server. |

The IV verb

The IV verb asks for the oldest inventory file following a requested date. The args field of the request conveys a reference date, as yyyymmddhhmmss but the date reference can be shortened on the right. For example, asking for an inventory 2006030512 would ask for the oldest inventory on or before noon on Mar. 5, 2006. The server responds with the contents of the inventory file enclosed in—BEGIN—and—END—. Lines terminate with NL codes.

The RF verb

The RF verb requests the transmission of a file from the archive, and is used during the recovery process. The args field identifies the file to be retrieved. If the file exists, it is returned using “Content-type: x-idahodatasafe/x-idahodatasafe”. Error 404 is returned if the file does not exist.

The DL Verb

The DL verb requests the download of the IdahoDataSafe™ client program from the server. A ZIP-file is returned containing the needed software.

### CONCLUSION

It will also be recognized by those skilled in the art that, while the invention has been described above in terms of one or more preferred embodiments, it is not limited thereto. Various features and aspects of the above-described invention may be used individually or jointly. Further, although the invention has been described in the context of its implementation in a particular environment and for particular purposes, e.g. in providing disaster recovery for trusted information sites, those skilled in the art will recognize that its usefulness is not limited thereto and that the present invention can be beneficially utilized in any number of environments and implementations. Accordingly, the claims set forth below should be construed in view of the full breath and spirit of the invention as disclosed herein.

What is claimed:

1. Creating the index of a file's contents, wherein the hash of the file's contents and a hash of a cryptographic triple (name of hashing algorithm, name of encryption algorithm and encryption key generation material) are used to form the index, and using that index to identify the file's contents, allows IdahoDataSafe™ to provide for the storage of confidential information on public servers without compromising security;

2. Recovering the true file names from an index and an inventory (an encrypted list of original file names and their corresponding index name) is computationally infeasible without possession of the values of cryptographic triple defined in claim 1, with care taken in normal cryptographic operations with respect to key and encryption algorithm choice;

3. Transmitting the index names and inventory (as defined in claims 1 and 2) in the clear over a public network does not compromise the confidentiality requirements of the client;

4. Storing the index names and inventory data on a server accessible by the public does not compromise the confidentiality requirements of the client;

5. Anyone with access to the public servers can learn only the count of files saved by the client, approximate sizes, and the frequency with which those files change;

6. It is computationally infeasible for anyone with access to the servers to learn the true file names or their contents provided reasonable algorithms and keys were chosen.

7. Disaster recovery requirements are met by storing the archived data on two or more geographically separated network-accessible servers.
